(19) United States
(12) Patent Application Publication
(10) Pub. No.: US 2006/0036602 A1
(43) Pub. Date: Feb. 16, 2006

(54) Distributed object-based storage system that stores virtualization maps in object attributes

(76) Inventors: Marc Jonathan Unangst, Pittsburgh, PA (US); Steven Andrew Moyer, Pittsburgh, PA (US)

Correspondence Address: Daniel H. Golub, 1701 Market Street, Philadelphia, PA, 19103, US

(21) Appl. No.: 10/918,200

(22) Filed: Aug. 13, 2004

(51) Int. Cl. G06F 17/30

(52) U.S. Cl. 707/9

(57) ABSTRACT

A distributed object-based storage system and method includes a plurality of object storage devices for storing object components, a metadata server coupled to each of the object storage devices, and one or more clients that access distributed, object-based files on the object storage devices. A file object having multiple components on different object storage devices is accessed by issuing a file access request from a client to an object storage device for a file object. In response to the file access request, a map is located that includes a list of object storage devices where components of the requested file object reside. The map is stored as at least one component object attribute on an object storage device. The map is sent to the client which retrieves the components of the requested file object by issuing access requests to each of the object storage devices on the list.

### FIELD OF THE INVENTION

The present invention generally relates to data storage methodologies, and, more particularly, to an object-based methodology wherein a map of a file object is stored as at least one component attribute on an object storage device.

### BACKGROUND OF THE INVENTION

With increasing reliance on electronic means of data communication, different models to efficiently and economically store a large amount of data have been proposed. A data storage mechanism requires not only a sufficient amount of physical disk space to store data, but various levels of fault tolerance or redundancy (depending on how critical the data is) to preserve data integrity in the event of one or more disk failures.

In a traditional networked storage system, a data storage device, such as a hard disk, is associated with a particular server or a particular server having a particular backup server. Thus, access to the data storage device is available only through the server associated with that data storage device. A client processor desiring access to the data storage device would, therefore, access the associated server through the network and the server would access the data storage device as requested by the client. By contrast, in an object-based data storage system, each object-based storage device communicates directly with clients over a network, possibly through routers and/or bridges. An example of an object-based storage system is shown in co-pending, commonly-owned, U.S. patent application Ser. No. 10/109,998, filed on Mar. 29, 2002, titled “Data File Migration from a Mirrored RAID to a Non-Mirrored XOR-Based RAID Without Rewriting the Data,” incorporated by reference herein in its entirety.

Existing object-based storage systems, such as the one described in co-pending application Ser. No. 10/109,998, typically include a plurality of object-based storage devices for storing object components, a metadata server, and one or more clients that access distributed, object-based files on the object storage devices. In such systems, a client typically accesses a file object having multiple components on different object storage devices by requesting a map of the file object (i.e., a list of object storage devices where components of the file object reside) from the metadata server, which may include a centralized map repository containing a map for each file object in the system. Once the map is retrieved from the metadata server and provided to the client, the client retrieves the components of the requested file object by issuing access requests to each of the object storage devices identified in the map.

In existing object-based storage systems, such as the one described above, the centralized storage of the file object maps of the metadata server, and the requirement that the metadata server retrieve a map for each file object before a client may access the file object, often results in a performance bottleneck. It would be desirable to provide an object-based storage system that decentralizes the storage of the file object maps away from the metadata server, in order to eliminate this performance bottleneck and improve system performance.

### SUMMARY OF THE INVENTION

The present invention is directed to a distributed object-based storage system and method that includes a plurality of object storage devices for storing object components, a metadata server coupled to each of the object storage devices, and one or more clients that access distributed, object-based files on the object storage devices. In the present invention, a file object having multiple components on different object storage devices is accessed by issuing a file access request from a client to an object storage device for a file object. In response to the file access request, a map is located that includes a list of object storage devices where components of the requested file object reside. The map is stored as at least one component object attribute on an object storage device and, in one embodiment, includes information about organization of the components of the requested file object on the object storage devices on the list. The map is sent to the client which retrieves the components of the requested file object by issuing access requests to each of the object storage devices on the list.

In one embodiment, the map located in response to the file access request is never stored on the metadata server. Alternatively, the map may be retrieved from an object storage device, passed to the metadata server, and then forwarded to the client.

In one embodiment, one or more redundant copies of the map are stored on different object storage devices. In this embodiment, each copy is stored as at least one component object attribute on one of the different object storage devices.

By storing the map as at least one component object on an object storage device, the present invention achieves at least two advantages over the prior art: (1) loss of the metadata server does not result in loss of maps, and (2) object ownership can be transferred without moving the data or metadata. Specifically, the component object attributes that identify the entity that is recognized as owning that component object can be updated without copying or otherwise moving the data associated with that component object.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention. In the drawings:

FIG. 1 illustrates an exemplary network-based file storage system designed around Object-Based Secure Disks (OBDs); and

FIG. 2 illustrates the decentralized storage of a map of a file object having multiple components on different OBDs, in accordance with the present invention.

### DETAILED DESCRIPTION OF PREFERRED EMBODIMENT

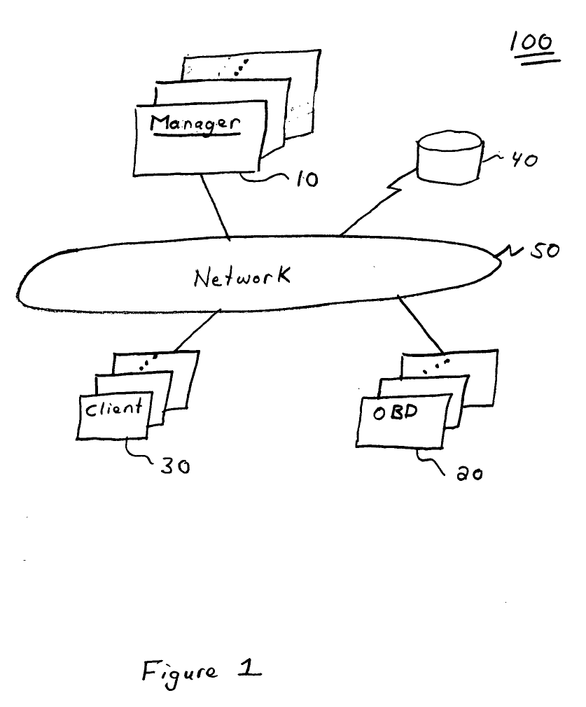

Reference will now be made in detail to the preferred embodiments of the present invention, examples of which are illustrated in the accompanying drawings. It is to be understood that the figures and descriptions of the present invention included herein illustrate and describe elements that are of particular relevance to the present invention, while eliminating, for purposes of clarity, other elements found in typical data storage systems or networks. FIG. 1 illustrates an exemplary network-based file storage system 100 designed around Object Based Secure Disks (OBDs) 20. File storage system 100 is implemented via a combination of hardware and software units and generally consists of manager software (simply, the “manager”) 10, OBDs 20, clients 30 and metadata server 40. It is noted that each manager is an application program code or software running on a corresponding server, e.g., metadata server 40. Clients 30 may run different operating systems, and thus present an operating system-integrated file system interface. Metadata stored on server 40 may include file and directory object attributes as well as directory object contents; however, in a preferred embodiment, attributes and directory object contents are not stored on metadata server 40. The term “metadata” generally refers not to the underlying data itself, but to the attributes or information that describe that data.

FIG. 1 shows a number of OBDs 10 attached to the network 50. An OBD 10 is a physical disk drive that stores data files in the network-based system 100 and may have the following properties: (1) it presents an object-oriented interface (rather than a sector-oriented interface); (2) it attaches to a network (e.g., the network 50) rather than to a data bus or a backplane (i.e., the OBDs 10 may be considered as first-class network citizens); and (3) it enforces a security model to prevent unauthorized access to data stored thereon.

The fundamental abstraction exported by an OBD 10 is that of an “object,” which may be defined as a variably-sized ordered collection of bits. Contrary to the prior art block-based storage disks, OBDs do not export a sector interface at all during normal operation. Objects on an OBD can be created, removed, written, read, appended to, etc. OBDs do not make any information about particular disk geometry visible, and implement all layout optimizations internally, utilizing higher-level information that can be provided through an OBD's direct interface with the network 50. In one embodiment, each data file and each file directory in the file system 100 are stored using one or more OBD objects. Because of object-based storage of data files, each file object may generally be read, written, opened, closed, expanded, created, deleted, moved, sorted, merged, concatenated, named, renamed, and include access limitations. Each OBD 10 communicates directly with clients 30 on the network 50, possibly through routers and/or bridges. The OBDs, clients, managers, etc., may be considered as “nodes” on the network 50. In system 100, no assumption needs to be made about the network topology except that various nodes should be able to contact other nodes in the system. Servers (e.g., metadata servers 40) in the network 50 merely enable and facilitate data transfers between clients and OBDs, but the servers do not normally implement such transfers.

Logically speaking, various system “agents” (i.e., the managers 10, the OBDs 20 and the clients 30) are independently-operating network entities. Manager 10 may provide day-to-day services related to individual files and directories, and manager 10 may be responsible for all file- and directory-specific states. Manager 10 creates, deletes and sets attributes on entities (i.e., files or directories) on clients' behalf. Manager 10 also carries out the aggregation of OBDs for performance and fault tolerance. “Aggregate” objects are objects that use OBDs in parallel and/or in redundant configurations, yielding higher availability of data and/or higher I/O performance. Aggregation is the process of distributing a single data file or file directory over multiple OBD objects, for purposes of performance (parallel access) and/or fault tolerance (storing redundant information). The aggregation scheme associated with a particular object is stored as an attribute of that object on an OBD 20. A system administrator (e.g., a human operator or software) may choose any aggregation scheme for a particular object. Both files and directories can be aggregated. In one embodiment, a new file or directory inherits the aggregation scheme of its immediate parent directory, by default. A change in the layout of an object may cause a change in the layout of its parent directory. Manager 10 may be allowed to make layout changes for purposes of load or capacity balancing.

The manager 10 may also allow clients to perform their own I/O to aggregate objects (which allows a direct flow of data between an OBD and a client), as well as providing proxy service when needed. As noted earlier, individual files and directories in the file system 100 may be represented by unique OBD objects. Manager 10 may also determine exactly how each object will be laid out—i.e., on which OBD or OBDs that object will be stored, whether the object will be mirrored, striped, parity-protected, etc. Manager 10 may also provide an interface by which users may express minimum requirements for an object's storage (e.g., “the object must still be accessible after the failure of any one OBD”).

Each manager 10 may be a separable component in the sense that the manager 10 may be used for other file system configurations or data storage system architectures. In one embodiment, the topology for the system 100 may include a “file system layer” abstraction and a “storage system layer” abstraction. The files and directories in the system 100 may be considered to be part of the file system layer, whereas data storage functionality (involving the OBDs 20) may be considered to be part of the storage system layer. In one topological model, the file system layer may be on top of the storage system layer.

A storage access module (SAM) (not shown) is a program code module that may be compiled into managers and clients. The SAM includes an I/O execution engine that implements simple I/O, mirroring, and map retrieval algorithms discussed below. The SAM generates and sequences the OBD-level operations necessary to implement system-level I/O operations, for both simple and aggregate objects.

Each manager 10 maintains global parameters, notions of what other managers are operating or have failed, and provides support for up/down state transitions for other managers. A benefit to the present system is that the location information describing at what data storage device (i.e., an OBD) or devices the desired data is stored may be located at a plurality of OBDs in the network. Therefore, a client 30 need only identify one of a plurality of OBDs containing location information for the desired data to be able to access that data. The data is may be returned to the client directly from the OBDs without passing through a manager.

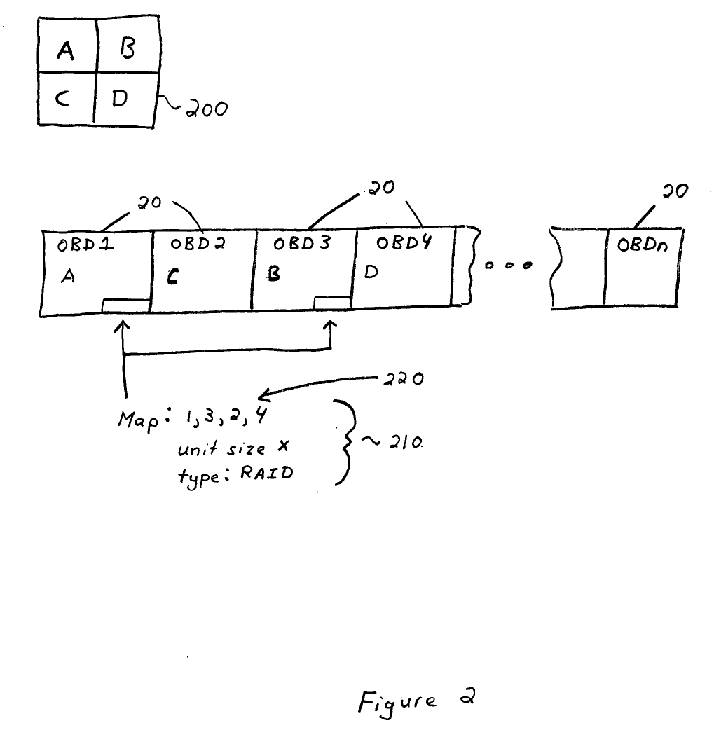

FIG. 2 illustrates the decentralized storage of a map 210 of an exemplary file object 200 having multiple components (e.g., components A, B, C, and D) stored on different OBDs 20, in accordance with the present invention. In the example shown, the object-based storage system includes n OBDs 20 (labeled OBD1, OBD2 . . . OBDn), and the components A, B, C, and D of exemplary file object 200 file are stored on OBD1, OBD2, OBD3 and OBD4, respectively. A map 210 that includes, among other things, a list 220 of object storage devices where the components of exemplary file object 200 reside. Map 210 is stored as at least one component object attribute on an object storage device (e.g., OBD1, OBD3, or both) and includes information about organization of the components of the file object on the object storage devices on the list. For example, list 220 specifies that the first, second, third and fourths components (i.e., components A, B, C and D) of file object 200 are stored on OBD1, OBD3, OBD2 and OBD4, respectively. In the embodiment shown, OBD1 and OBD3 contain redundant copies of map 210.

In the present invention, exemplary file object 200 having multiple components on different object storage devices is accessed by issuing a file access request from a client 30 to an object storage device 20 (e.g., OBD1) for the file object. In response to the file access request, map 210 (which is stored as at least one component object attribute on the object storage device) is located on the object storage device, and sent to the requesting client 30 which retrieves the components of the requested file object by issuing access requests to each of the object storage devices listed on the map.

In the preferred embodiment, metadata server 40 does not include a centralized repository of maps. Instead, map 210 may be retrieved from an OBD 20 and forwarded directly to client 30. Alternatively, upon retrieval of map 210 from OBD 20, map 210 may be sent to metadata server 40, and then forwarded to the client 30.

Although metadata server 40 does not maintain a centralized repository of maps 210, in one embodiment of the present invention metadata server 40 optionally includes information (or hints) identifying the OBD(s) where a map 210 corresponding to a given file object is likely located. In this embodiment, a client 30 seeking to access the given file object initially retrieves the corresponding hint from metadata server 40. The client 30 then directs its request to retrieve map 210 to the OBD identified by the hint. To the extent that the client 30 is unable to locate the requested map 210 on the OBD identified by the hint (i.e., the hint was erroneous), client 30 may direct its request for the map to one or more other OBDs until the map is located. Upon locating the map, client 30 may optionally send information identifying the OBD where the map was found to metadata server 40 in order to correct the erroneous hint.

In addition, a copy of the map hint can be stored on one or more OBDs other than the OBD(s) where the map 210 is stored, as an attribute of component objects that do not have the map stored therewith. This enables the client to access map 210 without first going to the manager, and eliminates the need for extra OBD calls in the event the client's initial request was not directed at one of the OBDs where the map 210 is stored. The client may also retrieve the map hint from the metadata server, or may retrieve it directly from an OBD, possibly as a portion of a directory or other index object.

Finally, it will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

What is claimed is:

1. In a distributed object-based storage system that includes a plurality of object storage devices for storing object components, a metadata server coupled to each of the object storage devices, and one or more clients that access distributed, object-based files on the object storage devices, a method for accessing a file object having multiple components on different object storage devices, comprising:
issuing a file access request from a client to an object storage device for a file object;
in response to the file access request, locating a map that includes a list of object storage devices where components of the requested file object reside, wherein the map is stored as at least one component object attribute on an object storage device;
sending the map to the client; and
issuing access requests from the client to each of the object storage devices on the list, in order to retrieve the components of the requested file object.

2. The method of claim 1, wherein the map includes information about organization of the components of the requested file object on the object storage devices on the list.

3. The method of claim 1, wherein the map is never stored on the metadata server.

4. The method of claim 1, wherein the map is retrieved from an object storage device, passed to the metadata server, and then forwarded to the client.

5. The method of claim 1, wherein one or more redundant copies of the map are stored on different object storage devices, each copy being stored as at least one component object attribute on one of the different object storage devices.

6. In a distributed object-based storage system that includes a plurality of object storage devices for storing object components, a metadata server coupled to each of the object storage devices, and one or more clients that access distributed, object-based files on the object storage devices, a system for accessing a file object having multiple components on different object storage devices, comprising:
a client that issues a file access request to an object storage device for a file object;
wherein, in response to the file access request, the object storage device locates a map that includes a list of object storage devices where components of the requested file object reside and sends the map to the client, wherein the map is stored as at least one component object attribute on an object storage device; and
wherein the client issues access requests to each of the object storage devices on the list, in order to retrieve the components of the requested file object.
